(19) United States
(12) Patent Application Publication
(10) Pub. No.: US 2025/0315315 A1
(43) Pub. Date: Oct. 9, 2025

(54) Batch Upgrade Management In Network Computing Environments

(71) Applicant: Rakuten Symphony, Inc, Tokyo (JP)

(72) Inventors: Tushar Anil Doshi, Santa Clara, CA (US); Rishi Mundada, Bangalore (IN)

(21) Appl. No.: 18/250,879

(22) PCT Filed: Dec. 9, 2022
(86) PCT No.: PCT/US2022/052396

§ 371 Date: Apr. 27, 2023

(51) Int. Cl. G06F 9/50; G06F 8/656; G06F 9/455; H04L 41/082; H04L 41/0823; H04L 41/0895

(52) U.S. Cl. CPC G06F 9/5077; G06F 8/656; G06F 9/5022; H04L 41/082; G06F 9/45558; G06F 2009/4557; H04L 41/0823; H04L 41/0895

(57) ABSTRACT

Systems and methods for efficient batch upgrading of compute nodes within a network computing platform. A method includes identifying a plurality of compute nodes scheduled to undergo an upgrade process and identifying an application executed by one or more of the plurality of compute nodes. The method includes determining a minimum node availability budget for the application and generating a batch upgrade scheme for the plurality of compute nodes, wherein the batch upgrade scheme upgrades a maximum quantity of the plurality of compute nodes in parallel while complying with the minimum node availability budget for the application.

### TECHNICAL FIELD

This disclosure relates generally to compute system configurations and specifically to generating efficient upgrade schemes for upgrading components of a network computing platform.

### SUMMARY

Systems and methods for efficient batch upgrading of compute nodes within a network computing platform. A method includes identifying a plurality of compute nodes scheduled to undergo an upgrade process and identifying an application executed by one or more of the plurality of compute nodes. The method includes determining a minimum node availability budget for the application and generating a batch upgrade scheme for the plurality of compute nodes, wherein the batch upgrade scheme upgrades a maximum quantity of the plurality of compute nodes in parallel while complying with the minimum node availability budget for the application.

### BACKGROUND

Numerous industries benefit from and rely upon cloud-based computing resources to store data, access data, and run applications based on the stored data. The hardware, firmware, and software for these cloud-based computing platforms will need to be upgraded over time, and each upgrade causes downtime for certain components of the system. In many cases, clients will require that all applications and storage resources be replicated across multiple nodes within the cloud-based computing platform to ensure the applications never experience significant downtime. In these cases, it can be important to generate efficient upgrade schemes that reduce the total time required to complete the upgrade while minimizing application downtime.

In view of the foregoing, disclosed herein are systems, methods, and devices for generating efficient upgrade schemes for upgrading components of a network computing platform.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a schematic block diagram of a system for automated deployment, scaling, and management of containerized workloads and services, wherein the system draws on storage distributed across shared storage resources;

FIG. 1B is a schematic block diagram of a system for automated deployment, scaling, and management of containerized workloads and services, wherein the system draws on storage within a stacked storage cluster;

FIG. 2 is a schematic block diagram of a system for automated deployment, scaling, and management of containerized applications;

FIG. 3 is a schematic block diagram illustrating a system for managing containerized workloads and services;

FIG. 4 is a schematic block diagram of an example cluster comprising a namespace, wherein a plurality of compute nodes and pods are mapped to the namespace;

FIG. 5 is a schematic block diagram of an example compute node configuration for a cluster;

FIG. 6 is a schematic block diagram of an example batch upgrade scheme for upgrading a maximum quantity of compute nodes in parallel while complying with minimum availability requirements for various applications;

FIG. 7 is a schematic block diagram illustrating factors considered by a batch upgrade algorithm;

FIG. 8 is a schematic flow chart diagram of a method for generating an efficient batch upgrade scheme for a plurality of compute nodes; and

FIG. 9 is a schematic block diagram of an example computing device suitable for implementing methods in accordance with embodiments of the invention.

### DETAILED DESCRIPTION

Disclosed herein are systems, methods, and devices for efficient upgrade batching to avoid application downtime in network computing environments. In traditional network computing platforms, such as the Kubernetes® platform, the order in which nodes are upgraded can cause issues in application downtime if more than one node is upgraded at the same time. The aim of the systems, methods, and devices described herein is to minimize the total time required to upgrade a platform while ensuring that all applications deployed on the platform remain live and do not experience downtime due to the upgrade process.

The batch upgrade schemes described herein seek to upgrade a maximum quantity of nodes simultaneously without causing applications to become unavailable due to the upgrade process. The batch upgrade schemes are generated while considering storage replication, the presence of redundant nodes, available resources, data availability, pod disruption budgets, and so forth. Each of these factors is considered by a batch upgrade algorithm when generating a batch upgrade scheme for upgrading the platform.

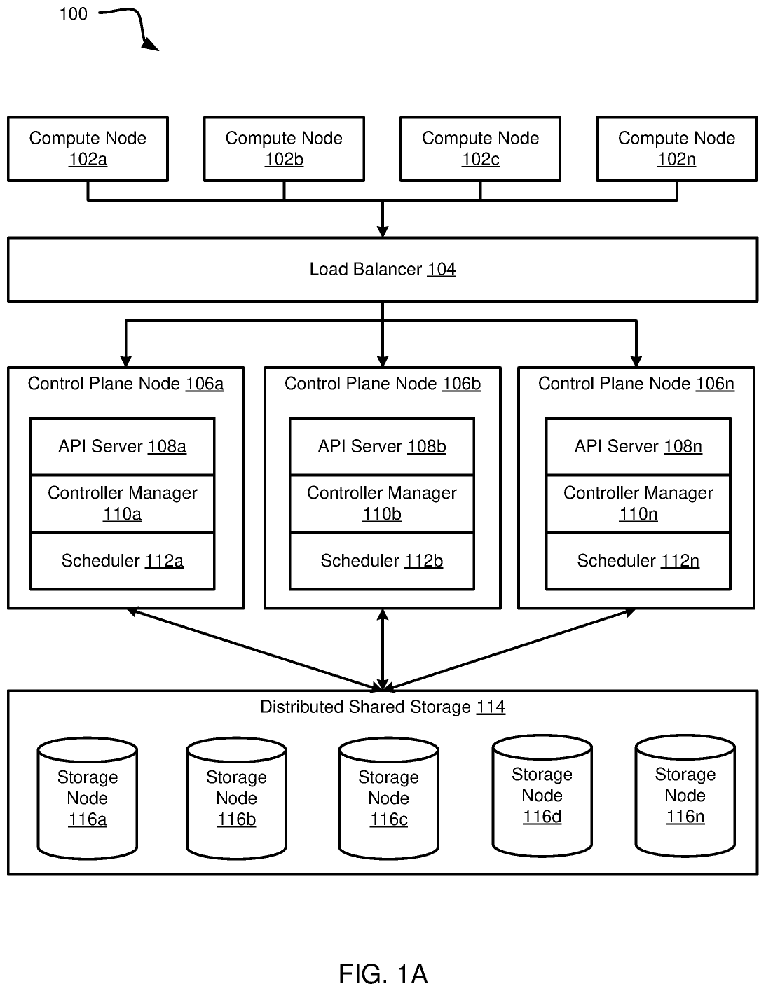

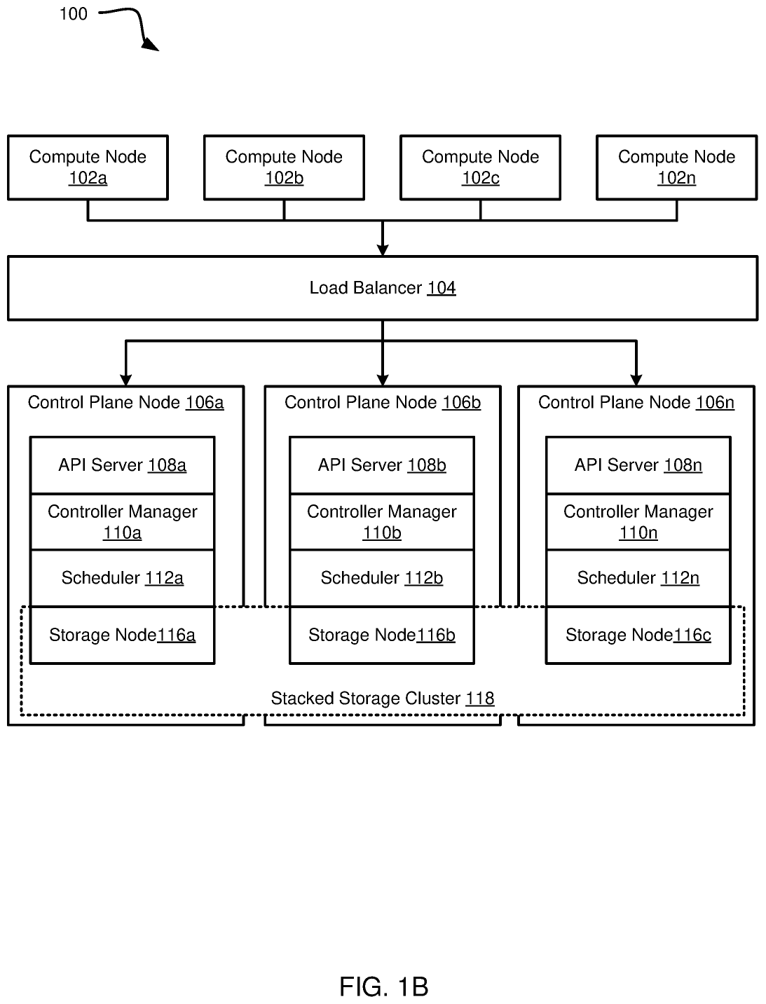

Referring now to the figures, FIGS. 1A and 1B are schematic illustrations of an example system 100 for automated deployment, scaling, and management of containerized workloads and services. The system 100 facilitates declarative configuration and automation through a distributed platform that orchestrates different compute nodes that may be controlled by central master nodes. The system 100 may include “n” number of compute nodes that can be distributed to handle pods.

The system 100 includes a plurality of compute nodes 102a, 102b, 102c, 102n (may collectively be referred to as compute nodes 102 as discussed herein) that are managed by a load balancer 104. The load balancer 104 assigns processing resources from the compute nodes 102 to one or more of the control plane nodes 106a, 106b, 106n (may collectively be referred to as control plane nodes 106 as discussed herein) based on need. In the example implementation illustrated in FIG. 1A, the control plane nodes 106 draw upon a distributed shared storage 114 resource comprising a plurality of storage nodes 116a, 116b 116c, 116d, 116n (may collectively be referred to as storage nodes 116 as discussed herein). In the example implementation illustrated in FIG. 1B, the control plane nodes 106 draw upon assigned storage nodes 116 within a stacked storage cluster 118.

The control planes 106 make global decisions about each cluster and detect and responds to cluster events, such as initiating a pod when a deployment replica field is unsatisfied. The control plane node 106 components may be run on any machine within a cluster. Each of the control plane nodes 106 includes an API server 108, a controller manager 110, and a scheduler 112.

The API server 108 functions as the front end of the control plane node 106 and exposes an Application Program Interface (API) to access the control plane node 106 and the compute and storage resources managed by the control plane node 106. The API server 108 communicates with the storage nodes 116 spread across different clusters. The API server 108 may be configured to scale horizontally, such that it scales by deploying additional instances. Multiple instances of the API server 108 may be run to balance traffic between those instances.

The controller manager 110 embeds core control loops associated with the system 100. The controller manager 110 watches the shared state of a cluster through the API server 108 and makes changes attempting to move the current state of the cluster toward a desired state. The controller manager 110 may manage one or more of a replication controller, endpoint controller, namespace controller, or service accounts controller.

The scheduler 112 watches for newly created pods without an assigned node, and then selects a node for those pods to run on. The scheduler 112 accounts for individual and collective resource requirements, hardware constraints, software constraints, policy constraints, affinity specifications, anti-affinity specifications, data locality, inter-workload interference, and deadlines.

The storage nodes 116 function as a distributed storage resources with backend service discovery and database. The storage nodes 116 may be distributed across different physical or virtual machines. The storage nodes 116 monitor changes in clusters and store state and configuration data that may be accessed by a control plane node 106 or a cluster. The storage nodes 116 allow the system 100 to support discovery service so that deployed applications can declare their availability for inclusion in service.

In some implementations, the storage nodes 116 are organized according to a key-value store configuration, although the system 100 is not limited to this configuration. The storage nodes 116 may create a database page for each record such that the database pages do not hamper other records while updating one. The storage nodes 116 may collectively maintain two or more copies of data stored across all clusters on distributed machines.

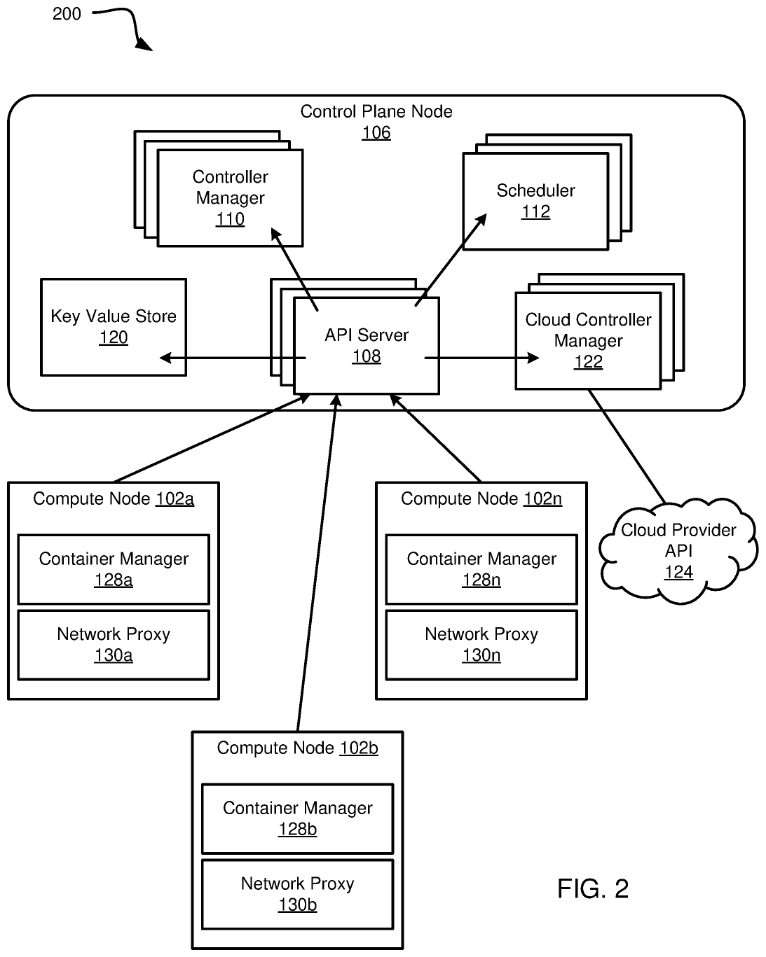

FIG. 2 is a schematic illustration of a cluster 200 for automating deployment, scaling, and management of containerized applications. The cluster 200 illustrated in FIG. 2 is implemented within the systems 100 illustrated in FIGS. 1A-1B, such that the control plane node 106 communicates with compute nodes 102 and storage nodes 116 as shown in FIGS. 1A-1B. The cluster 200 groups containers that make up an application into logical units for management and discovery.

The cluster 200 deploys a cluster of worker machines, identified as compute nodes 102a, 102b, 102n. The compute nodes 102a-102n run containerized applications, and each cluster has at least one node. The compute nodes 102a-102n host pods that are components of an application workload. The compute nodes 102a-102n may be implemented as virtual or physical machines, depending on the cluster. The cluster 200 includes a control plane node 106 that manages compute nodes 102a-102n and pods within a cluster. In a production environment, the control plane node 106 typically manages multiple computers and a cluster runs multiple nodes. This provides fault tolerance and high availability.

The key value store 120 is a consistent and available key value store used as a backing store for cluster data. The controller manager 110 manages and runs controller processes. Logically, each controller is a separate process, but to reduce complexity in the cluster 200, all controller processes are compiled into a single binary and run in a single process. The controller manager 110 may include one or more of a node controller, job controller, endpoint slice controller, or service account controller.

The cloud controller manager 122 embeds cloud-specific control logic. The cloud controller manager 122 enables clustering into a cloud provider API 124 and separates components that interact with the cloud platform from components that only interact with the cluster. The cloud controller manager 122 may combine several logically independent control loops into a single binary that runs as a single process. The cloud controller manager 122 may be scaled horizontally to improve performance or help tolerate failures.

The control plane node 106 manages any number of compute nodes 126. In the example implementation illustrated in FIG. 2, the control plane node 106 is managing three nodes, including a first node 126a, a second node 126b, and an nth node 126n (which may collectively be referred to as compute nodes 126 as discussed herein). The compute nodes 126 each include a container manager 128 and a network proxy 130.

The container manager 128 is an agent that runs on each compute node 126 within the cluster managed by the control plane node 106. The container manager 128 ensures that containers are running in a pod. The container manager 128 may take a set of specifications for the pod that are provided through various mechanisms, and then ensure those specifications are running and healthy.

The network proxy 130 runs on each compute node 126 within the cluster managed by the control plane node 106. The network proxy 130 maintains network rules on the compute nodes 126 and allows network communication to the pods from network sessions inside or outside the cluster.

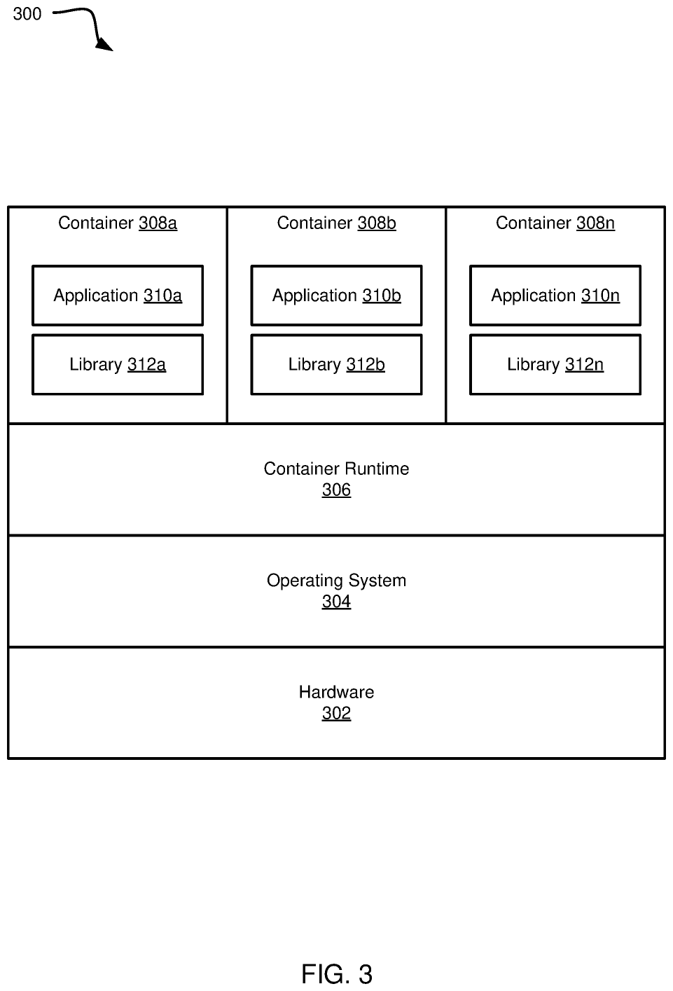

FIG. 3 is a schematic diagram illustrating a system 300 for managing containerized workloads and services. The system 300 includes hardware 302 that supports an operating system 304 and further includes a container runtime 306, which refers to the software responsible for running containers 308. The hardware 302 provides processing and storage resources for a plurality of containers 308a, 308b, 308n that each run an application 310 based on a library 312. The system 300 discussed in connection with FIG. 3 is implemented within the systems 100, 200 described in connection with FIGS. 1A-1B and 2.

The containers 308 function similar to a virtual machine but have relaxed isolation properties and share an operating system 304 across multiple applications 310. Therefore, the containers 308 are considered lightweight. Similar to a virtual machine, a container has its own file systems, share of CPU, memory, process space, and so forth. The containers 308 are decoupled from the underlying instruction and are portable across clouds and operating system distributions.

Containers 308 are repeatable and may decouple applications from underlying host infrastructure. This makes deployment easier in different cloud or OS environments. A container image is a ready-to-run software package, containing everything needed to run an application, including the code and any runtime it requires, application and system libraries, and default values for essential settings. By design, a container 308 is immutable such that the code of a container 308 cannot be changed after the container 308 begins running.

The containers 308 enable certain benefits within the system. Specifically, the containers 308 enable agile application creation and deployment with increased ease and efficiency of container image creation when compared to virtual machine image use. Additionally, the containers 308 enable continuous development, integration, and deployment by providing for reliable and frequent container image build and deployment with efficient rollbacks due to image immutability. The containers 308 enable separation of development and operations by creating an application container at release time rather than deployment time, thereby decoupling applications from infrastructure. The containers 308 increase observability at the operating system-level, and also regarding application health and other signals. The containers 308 enable environmental consistency across development, testing, and production, such that the applications 310 run the same on a laptop as they do in the cloud. Additionally, the containers 308 enable improved resource isolation with predictable application 310 performance. The containers 308 further enable improved resource utilization with high efficiency and density.

The containers 308 enable application-centric management and raise the level of abstraction from running an operating system 304 on virtual hardware to running an application 310 on an operating system 304 using logical resources. The containers 304 are loosely coupled, distributed, elastic, liberated micro-services. Thus, the applications 310 are broken into smaller, independent pieces and can be deployed and managed dynamically, rather than a monolithic stack running on a single-purpose machine.

The containers 308 may include any container technology known in the art such as DOCKER, LXC, LCS, KVM, or the like. In a particular application bundle 406, there may be containers 308 of multiple distinct types in order to take advantage of a particular container's capabilities to execute a particular role 416. For example, one role 416 of an application bundle 406 may execute a DOCKER container 308 and another role 416 of the same application bundle 406 may execute an LCS container 308.

The system 300 allows users to bundle and run applications 310. In a production environment, users may manage containers 308 and run the applications to ensure there is no downtime. For example, if a singular container 308 goes down, another container 308 will start. This is managed by the control plane nodes 106, which oversee scaling and failover for the applications 310.

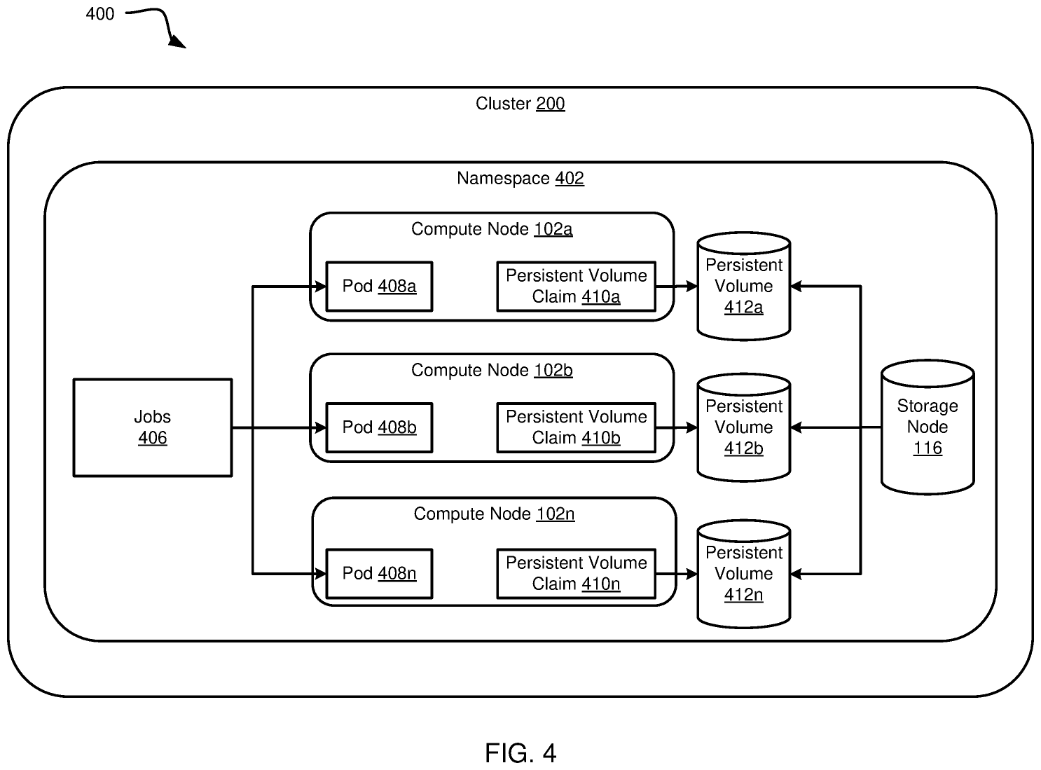

FIG. 4 is a schematic diagram of an example system 400 for executing jobs with one or more compute nodes associated with a cluster. The system 400 includes a cluster 200, such as the cluster first illustrated in FIG. 2. The cluster 200 includes a namespace 402. Several compute nodes 102 are bound to the namespace 402, and each compute node 102 includes a pod 408 and a persistent volume claim 410. In the example illustrated in FIG. 4, the namespace 402 is associated with three compute nodes 102a, 102b, 102n, but it should be appreciated that any number of compute nodes 102 may be included within the cluster 200. The first compute node 102a includes a first pod 408a and a first persistent volume claim 410a that draws upon a first persistent volume 412a. The second compute node 102b includes a second pod 408b and a second persistent volume claim 410b that draws upon a second persistent volume 412b. Similarly, the third compute node 102n includes a third pod 408n and a third persistent volume claim 410n that draws upon a third persistent volume 412n. Each of the persistent volumes 412 may draw from a storage node 116. The cluster 200 executes jobs 406 that feed into the compute nodes 102 associated with the namespace 402.

Numerous storage and compute nodes may be dedicated to different namespaces 402 within the cluster 200. The namespace 402 may be referenced through an orchestration layer by an addressing scheme, e.g., <Bundle ID>.<Role ID>.<Name>. In some embodiments, references to the namespace 402 of another job 406 may be formatted and processed according to the JINJA template engine or some other syntax. Accordingly, each task may access the variables, functions, services, etc. in the namespace 402 of another task on order to implement a complex application topology.

Each job 406 executed by the cluster 200 maps to one or more pods 408. Each of the one or more pods 408 includes one or more containers 308. Each resource allocated to the application bundle is mapped to the same namespace 402. The pods 408 are the smallest deployable units of computing that may be created and managed in the systems described herein. The pods 408 constitute groups of one or more containers 308, with shared storage and network resources, and a specification of how to run the containers 308. The pods' 408 contents are co-located and co-scheduled and run in a shared context. The pods 408 are modeled on an application-specific “logical host,” i.e., the pods 408 include one or more application containers 308 that are relatively tightly coupled.

The pods 408 are designed to support multiple cooperating processes (as containers 308) that form a cohesive unit of service. The containers 308 in a pod 408 are co-located and co-scheduled on the same physical or virtual machine in the cluster 200. The containers 308 can share resources and dependencies, communicate with one another, and coordinate when and how they are terminated. The pods 408 may be designed as relatively ephemeral, disposable entities. When a pod 408 is created, the new pod 408 is schedule to run on a node in the cluster. The pod 408 remains on that node until the pod 408 finishes executing, and then the pod 408 is deleted, evicted for lack of resources, or the node fails.

The namespaces 402 provide a mechanism for isolating groups of API resources within a single cluster 200. Many system-wide security policies are scoped to namespaces 402. In a multi-tenant environment, a namespace 402 helps segment a tenant's workload into a logical and distinct management units. In some cases, system administrators will isolate each workload to its own namespace 402, even if multiple workloads are operated by the same tenant. This ensures that each workload has its own identity and can be configured with an appropriate security policy.

The system 400 is valuable for applications that require one or more of the following: stable and unique network identifiers; stable and persistent storage; ordered and graceful deployment and scaling; or ordered and automated rolling updated. In each of the foregoing, “stable” is synonymous with persistent across pod rescheduling. If an application does not require any stable identifiers or ordered deployment, deletion, or scaling, then the application may be deployed using a workload object that provides a set of stateless replicas.

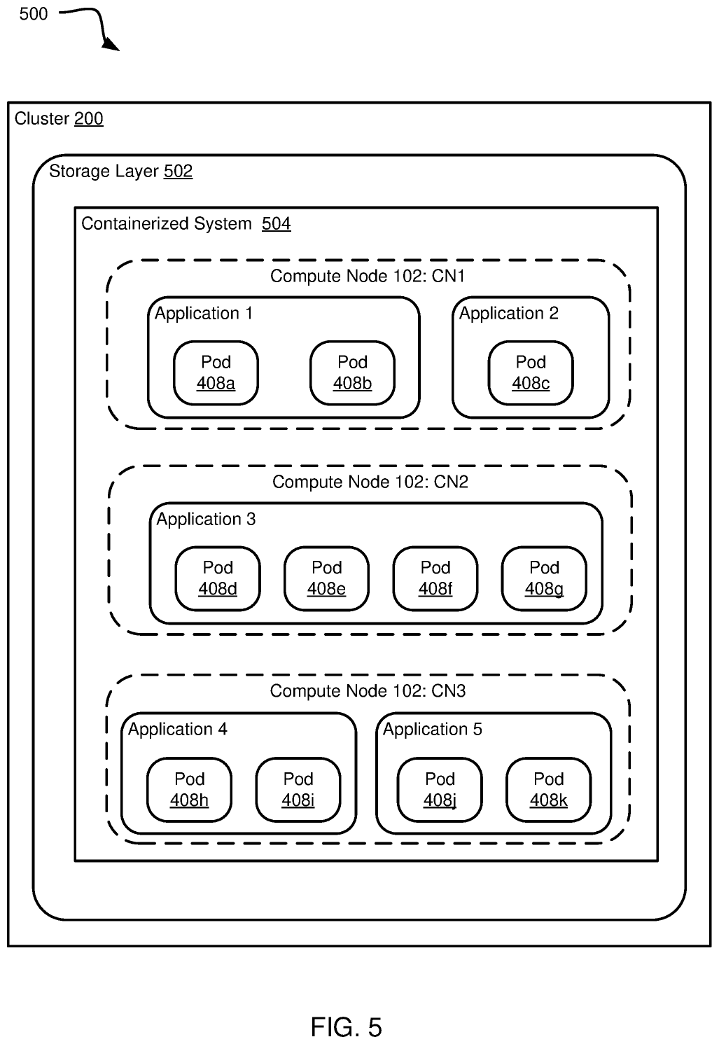

FIG. 5 is a schematic block diagram of an example configuration 500 for a cluster 200. The example cluster 200 includes a storage layer 502 and a containerized system 504 operating in connection with the storage layer 502. The containerized system 504 may include the components discussed in connection with FIGS. 1-4 for executing containerized workloads. The example containerized system 504 depicted in FIG. 5 includes three different compute nodes 102, including CN1, CN2, and CN3. Each compute node 102 is executing one or more applications, such that CN1 is executing Applications 1 and 2, CN2 is executing Application 3, and CN3 is executing Applications 4 and 5. Each of the applications is executed by one or more of the pods 408a-408k.

In the example illustrated in FIG. 5, there are two applications mapped to the first compute node CN1, including Application 1 and Application 2. Application 1 is executed by two pods, including pod 408a and pod 408b. Application 2 is executed by a single pod 408c. The second compute node CN2 is dedicated to a single application, namely Application 3. Application 3 is executed by numerous pods, including pod 408d-408g. There are two applications mapped to the third compute node CN3, including Application 4 and Application 5. Application 4 is executed by two pods, including pods 408h and 408i. Application 5 is executed by two pods, including 408j and 408k.

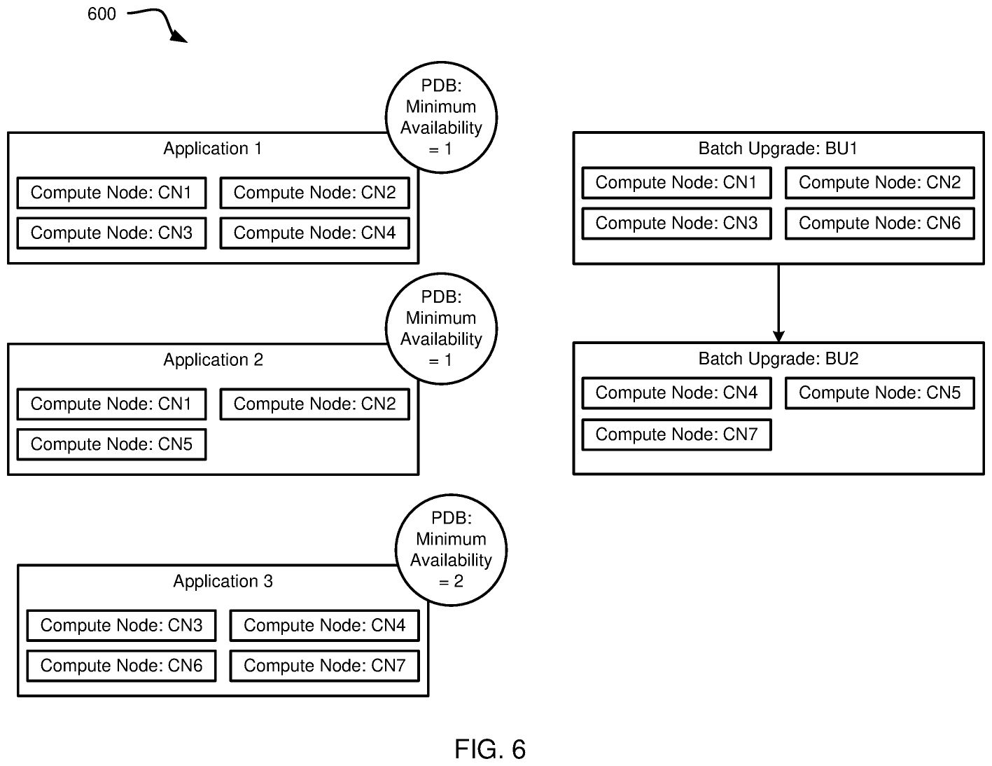

FIG. 6 is a schematic diagram of an example configuration 600 for multi-node parallel application execution and batch upgrading of compute nodes while minimizing application downtime.

The configuration 600 executes applications in parallel over multiple compute nodes 102 to reduce application downtime. Multi-node parallel application execution may span multiple clusters 200 or instances of a network computing platform. With batch multi-node parallel applications, clients can run large-scale and high-performance computing applications while reducing the risk the applications will go down or become unavailable. Thus, if multiple copies of the same application are running on different compute nodes 102, then if one or more of the compute nodes 102 becomes unavailable, other copies of the application will still be alive.

Some systems implement a pod disruption budget (PDB) that establishes a minimum application availability. In many cases, the PDB minimum availability is set to one, meaning that at least one copy of the application must remain alive at all times. In other cases, the PDB minimum availability may be set to a higher quantity of available instances of the application. The PDB minimum availability may be set with some flexibility, such that a mandatory minimum availability is set to one, but an ideal or desired minimum availability is set to two or more. These configurations will likely depend on the type of application being run, the number of people using the application, the complexity of the application, and so forth.

As shown in FIG. 6, a single compute node instance may run multiple applications. When that compute node instance goes down, then all applications running on that compute node will become unavailable. In the example configuration 600, compute node CN1 is executing Application 1 and Application 2; compute node CN2 is executing Application 1 and Application 2; compute node CN3 is executing Application 1 and Application 3; and compute node CN4 is executing Application 1 and Application 3. It should be appreciated that the configuration 600 shown in FIG. 6 is an example only and may be significantly simpler than actual systems. Further as shown in the configuration 600, Application 1 is configured with a PDB minimum availability of one, Application 2 is configured with a PDB minimum availability of one, and Application 3 is configured with a PDB minimum availability of two.

The configuration 600 shows an example parallel batch upgrade configuration for upgrading all compute nodes while complying with the PDB minimum availability for each application. The first batch upgrade BU1 upgrades compute nodes CN1, CN2, CN3, and CN6 in parallel. The second batch upgrade BU2 upgrades compute nodes CN4, CN5, and CN7 in parallel.

When the first batch upgrade BU1 is in process, Application 1 relies on a singular remaining compute node CN4, because the other compute nodes CN1, CN2, and CN3 are being upgraded. Additionally, during the first batch upgrade BU1, Application 2 relies on a singular remaining compute node CN5, because the other compute nodes CN1, CN2 are being upgraded. Applications 1 and 2 thereby comply with their PDB minimum availability requirements while multiple compute nodes are upgraded in parallel. The batch upgrades BU1 and BU2 ensure that each of Application 1, Application 2, and Application 3 can comply with their respective PDB minimum availability requirements. Notably, Application 3 requires that two compute nodes be available at all times, and therefore, only two of the four compute nodes for Application 3 may be upgraded in parallel.

The configuration 600 is an improvement over traditional serial upgrade systems wherein compute nodes 102 are upgraded one-by-one to reduce or eliminate application downtime. In these traditional serial upgrade systems, the cluster 200 upgrades one compute node 102 at a time. This can take an unacceptably long time to complete. In an example implementation, each compute node 102 requires ten minutes to complete an upgrade sequence. If an example cluster 200 includes 100 nodes, then the full upgrade process will take 1,000 minutes, which is nearly 17 hours. Therefore, it is desirable to upgrade multiple compute nodes 102 in parallel to reduce the total time to complete the upgrade process.

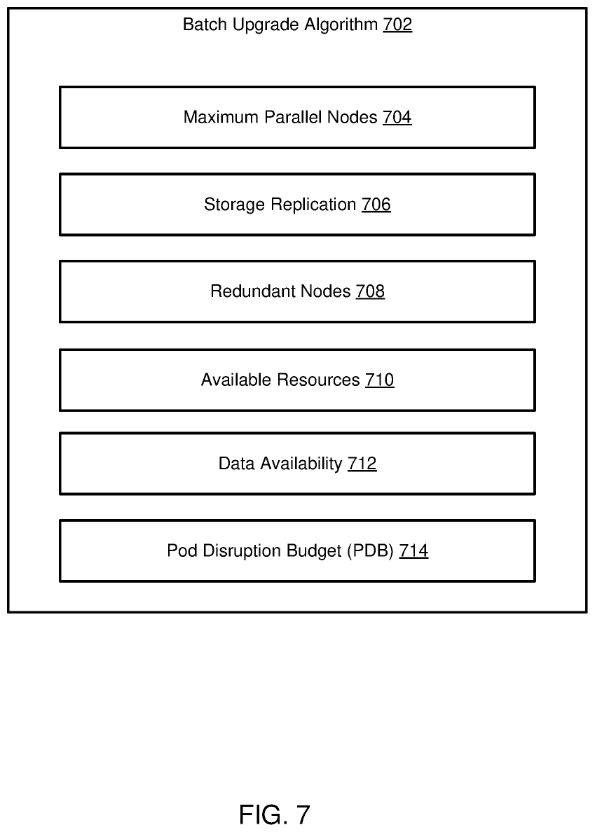

FIG. 7 is a block diagram illustrating the factors involved in a batch upgrade algorithm 702. The batch upgrade algorithm 702 generates a scheme for upgrading a group of compute nodes 102. The batch upgrade algorithm 702 seeks to upgrade a maximum quantity of nodes in parallel 704 to decrease the total time required to upgrade all applicable nodes. However, the desire to upgrade the maximum quantity of parallel nodes 704 is balanced against other considerations, including the available storage replication 706, the presence of redundant nodes 708, the currently available resources 710, the current or expected data availability 712, and the requirements of a pod disruption budget (PDB) 714.

The batch upgrade algorithm 702 is configured to generate a scheme for upgrading a plurality of compute nodes 102. The batch upgrade algorithm 702 may be integrated within a multi-data center automation platform configured to oversee and manage the operations of multiple bare metal servers and clusters 200 within a Kubernetes® platform. The batch upgrade algorithm 702 proposes a schema for upgrading the highest quantity of compute nodes 102 in parallel as possible while minimizing or eliminating application downtime during the upgrade process.

The batch upgrade algorithm 702 considers storage replication 706 when generating the batch upgrade scheme. Specifically, the batch upgrade algorithm 702 considers whether necessary storage required for executing certain applications is distributed across different clusters 200, persistent volumes 412, or storage nodes 116. If the required storage resources are copied across multiple instances, then the batch upgrade algorithm 702 may ensure that at least one storage instance remains live at all times during the upgrade process.

The batch upgrade algorithm 702 considers the presence of redundant nodes 708 executing the same application. As discussed in connection with FIG. 6, multiple compute nodes 102 may execute the same application in parallel. The batch upgrade algorithm 702 identifies redundant nodes 708 and ensures that at least one of the redundant nodes 708 for each application remains live during the upgrade process.

The batch upgrade algorithm 702 balances the desire to upgrade the maximum quantity of nodes in parallel 704 against the desire to ensure that sufficient resources are available 710 to continue operations. The batch upgrade algorithm 702 ensures that sufficient resources will continue to be live and available during the upgrade process, including CPU (central processing unit), GPU (graphics processing unit), RAM (random access memory), disk storage, and so forth. The batch upgrade algorithm 702 further ensures that sufficient data will be available 712 to continue operations during the upgrade process.

The batch upgrade algorithm 702 ensures that each application complies with its own pod disruption budget (PDB) 714. As discussed in connection with FIG. 6, the PDB 714 sets a minimum availability for the application. If the PDB 714 minimum availability is one, then at least one pod 408 or compute node 102 executing the application must remain live at all times. If the PDB 714 minimum availability is four, then at least four pods 408 or compute nodes 102 executing the application must remain live at all times.

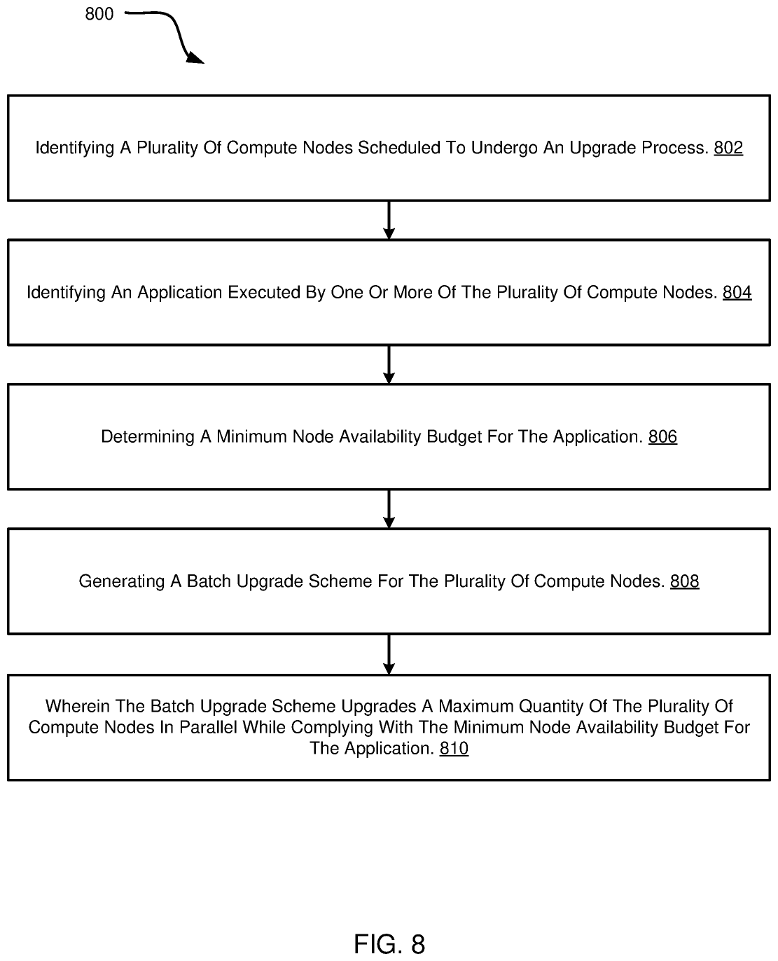

FIG. 8 is a schematic flow chart diagram of a method 800 for generating efficient upgrade schemas to upgrade a maximum quantity of nodes within a network computing environment without experiencing application downtime. The method 800 includes identifying at 802 a plurality of compute nodes scheduled to undergo an upgrade process. The method 800 includes identifying at 804 an application executed by one or more of the plurality of compute nodes. The method 800 includes determining at 806 a minimum node availability budget for the application. The method 800 includes generating at 808 a batch upgrade scheme for the plurality of compute nodes. The method 800 is such that the batch upgrade scheme upgrades a maximum quantity of the plurality of compute nodes in parallel while complying with the minimum node availability budget for the application (see 810).

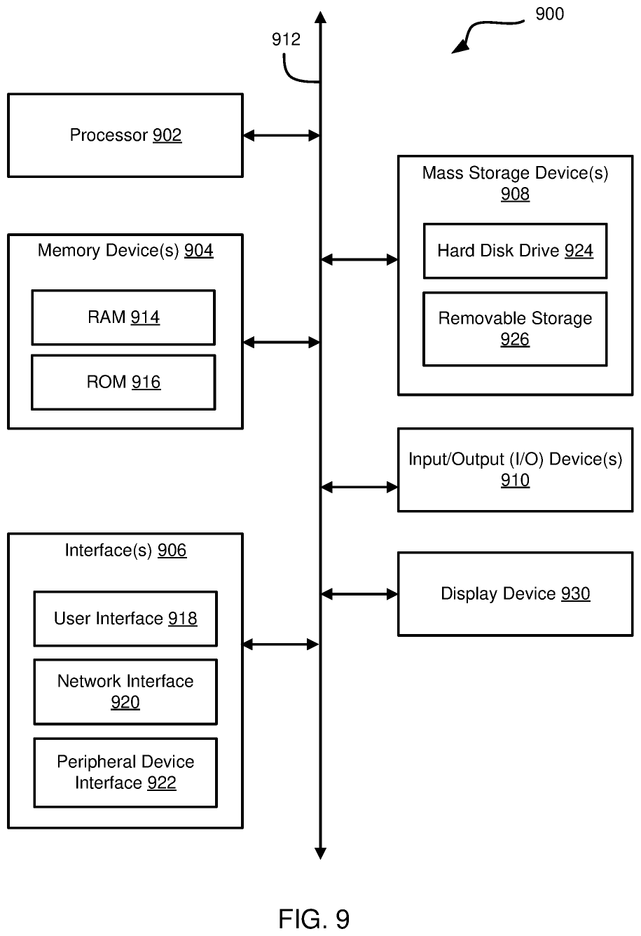

FIG. 9 illustrates a schematic block diagram of an example computing device 900. The computing device 900 may be used to perform various procedures, such as those discussed herein. The computing device 900 can perform various monitoring functions as discussed herein, and can execute one or more application programs, such as the application programs or functionality described herein. The computing device 900 can be any of a wide variety of computing devices, such as a desktop computer, in-dash computer, vehicle control system, a notebook computer, a server computer, a handheld computer, tablet computer and the like.

The computing device 900 includes one or more processor(s) 904, one or more memory device(s) 904, one or more interface(s) 906, one or more mass storage device(s) 908, one or more Input/output (I/O) device(s) 910, and a display device 930 all of which are coupled to a bus 912. Processor(s) 904 include one or more processors or controllers that execute instructions stored in memory device(s) 904 and/or mass storage device(s) 908. Processor(s) 904 may also include several types of computer-readable media, such as cache memory.

Memory device(s) 904 include various computer-readable media, such as volatile memory (e.g., random access memory (RAM) 914) and/or nonvolatile memory (e.g., read-only memory (ROM) 916). Memory device(s) 904 may also include rewritable ROM, such as Flash memory.

Mass storage device(s) 908 include various computer readable media, such as magnetic tapes, magnetic disks, optical disks, solid-state memory (e.g., Flash memory), and so forth. As shown in FIG. 9, a particular mass storage device 908 is a hard disk drive 924. Various drives may also be included in mass storage device(s) 908 to enable reading from and/or writing to the various computer readable media. Mass storage device(s) 908 include removable media 926 and/or non-removable media.

I/O device(s) 910 include various devices that allow data and/or other information to be input to or retrieved from computing device 900. Example I/O device(s) 910 include cursor control devices, keyboards, keypads, microphones, monitors or other display devices, speakers, printers, network interface cards, modems, and the like.

Display device 930 includes any type of device capable of displaying information to one or more users of computing device 900. Examples of display device 930 include a monitor, display terminal, video projection device, and the like.

Interface(s) 906 include various interfaces that allow computing device 900 to interact with other systems, devices, or computing environments. Example interface(s) 906 may include any number of different network interfaces 920, such as interfaces to local area networks (LANs), wide area networks (WANs), wireless networks, and the Internet. Other interface(s) include user interface 918 and peripheral device interface 922. The interface(s) 906 may also include one or more user interface elements 918. The interface(s) 906 may also include one or more peripheral interfaces such as interfaces for printers, pointing devices (mice, track pad, or any suitable user interface now known to those of ordinary skill in the field, or later discovered), keyboards, and the like.

Bus 912 allows processor(s) 904, memory device(s) 904, interface(s) 906, mass storage device(s) 908, and I/O device(s) 910 to communicate with one another, as well as other devices or components coupled to bus 912. Bus 912 represents one or more of several types of bus structures, such as a system bus, PCI bus, IEEE bus, USB bus, and so forth.

For purposes of illustration, programs and other executable program components are shown herein as discrete blocks, such as block 302 for example, although it is understood that such programs and components may reside at various times in different storage components of computing device 900 and are executed by processor(s) 902. Alternatively, the systems and procedures described herein, including programs or other executable program components, can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to preferred features of further embodiments:

Example 1 is a method for efficient batch upgrading of resources within a network computing platform. A method includes identifying a plurality of compute nodes scheduled to undergo an upgrade process. The method includes identifying an application executed by one or more of the plurality of compute nodes. The method includes determining a minimum node availability budget for the application. The method includes generating a batch upgrade scheme for the plurality of compute nodes. The method is such that the batch upgrade scheme upgrades a maximum quantity of the plurality of compute nodes in parallel while complying with the minimum node availability budget for the application.

Example 2 is a method as in Example 1, wherein the upgrade process will render the plurality of compute nodes unavailable for a time period.

Example 3 is a method as in any of Examples 1-2, wherein identifying the application executed by the one or more of the plurality of compute nodes comprises identifying a plurality of applications; and wherein at least a portion of the plurality of applications is executed with redundancy such that the portion of the plurality of applications is executed by two or more compute nodes simultaneously.

Example 4 is a method as in any of Examples 1-3, wherein one compute node of the plurality of compute nodes is configured to execute two or more of the plurality of applications.

Example 5 is a method as in any of Examples 1-4, wherein the minimum node availability budget for the application requires that at least one compute node running the application be live at all times.

Example 6 is a method as in any of Examples 1-5, wherein generating the batch upgrade scheme to comply with the minimum node availability budget for the application comprises ensuring that fewer than all compute nodes running the application are upgraded simultaneously such that at least one compute node running the application is live at all times.

Example 7 is a method as in any of Examples 1-6, wherein generating the batch upgrade scheme further comprises optimizing the batch upgrade scheme to ensure that sufficient resources are available to continue operations during the upgrade process.

Example 8 is a method as in any of Examples 1-7, wherein the sufficient resources comprises: sufficient CPU (central processing unit) resources are available to continue operations; sufficient GPU (graphics processing unit) resources are available to continue operations; sufficient RAM (random access memory) resources are available to continue operations; and sufficient disk storage resources are available to continue operations.

Example 9 is a method as in any of Examples 1-8, wherein generating the batch upgrade scheme further comprises optimizing the batch upgrade scheme to ensure that sufficient data is available to execute the application during the upgrade process.

Example 10 is a method as in any of Examples 1-9, wherein the method is implemented in a containerized workload management platform.

Example 11 is a method as in any of Examples 1-10, wherein the containerized workload management platform comprises a Kubernetes® construct.

Example 12 is a method as in any of Examples 1-11, wherein the application comprises a plurality of applications, and wherein generating the batch upgrade scheme comprises ensuring that none of the plurality of applications become unavailable during the upgrade process.

Example 13 is a method as in any of Examples 1-12, wherein the batch upgrade scheme comprises a plurality of upgrade groups, wherein each of the plurality of upgrade groups comprises one or more compute nodes to be upgraded in parallel, and wherein the plurality of upgrade groups are upgraded serially.

Example 14 is a method as in any of Examples 1-13, wherein each of the plurality of compute nodes is associated with a cluster within a containerized workload management system.

Example 15 is a method as in any of Examples 1-14, wherein the containerized workload management system comprises a plurality of clusters, and wherein each of the plurality of clusters comprises: a control plane node comprising an API (application program interface) server in communication with all compute nodes mapped to the applicable cluster.

Example 16 is a method as in any of Examples 1-15, wherein generating the batch upgrade scheme comprises first upgrading the control plane node of each of the plurality of clusters prior to upgrading the plurality of compute nodes.

Example 17 is a method as in any of Examples 1-16, wherein generating the batch upgrade scheme further comprises selecting an optimal date and time to execute the batch upgrade scheme.

Example 18 is a method as in any of Examples 1-17, wherein selecting the optimal date and time to execute the batch upgrade scheme comprises selecting based on time-based usage history for the application.

Example 19 is a method as in any of Examples 1-18, wherein the application is a cloud-based application and wherein the plurality of compute nodes are implemented within a cloud-native network platform.

Example 20 is a method as in any of Examples 1-19, wherein each of the plurality of compute nodes comprises one or more pods, and wherein generating the batch upgrade scheme comprises upgrading a plurality of pods in parallel.

Example 21 is a system comprising one or more processors configured to execute instructions stored in non-transitory computer readable storage medium, wherein the instructions comprise any of the method steps of Examples 1-20.

Example 22 is non-transitory computer readable storage medium comprising instructions to be executed by one or more processors, wherein the instructions comprise any of the method steps of Examples 1-20.

It will be appreciated that various features disclosed herein provide significant advantages and advancements in the art. The following claims are exemplary of some of those features.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment.

It is to be understood that any features of the above-described arrangements, examples, and embodiments may be combined in a single embodiment comprising a combination of features taken from any of the disclosed arrangements, examples, and embodiments.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements.

Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Further, where appropriate, functions described herein can be performed in one or more of: hardware, software, firmware, digital components, or analog components. For example, one or more application specific integrated circuits (ASICs) or field programmable gate arrays (FPGAs) can be programmed to carry out one or more of the systems and procedures described herein. Certain terms are used throughout the following description and claims to refer to particular system components. As one skilled in the art will appreciate, components may be referred to by different names. This document does not intend to distinguish between components that differ in name, but not function.

The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method comprising:
identifying a plurality of compute nodes scheduled to undergo an upgrade process;
identifying an application executed by one or more of the plurality of compute nodes;
determining a minimum node availability budget for the application; and
generating a batch upgrade scheme for the plurality of compute nodes;
wherein the batch upgrade scheme upgrades a maximum quantity of the plurality of compute nodes in parallel while complying with the minimum node availability budget for the application.

2. The method of claim 1, wherein the upgrade process will render the plurality of compute nodes unavailable for a time period.

3. The method of claim 1, wherein identifying the application executed by the one or more of the plurality of compute nodes comprises identifying a plurality of applications; and
wherein at least a portion of the plurality of applications is executed with redundancy such that the portion of the plurality of applications is executed by two or more compute nodes simultaneously.

4. The method of claim 3, wherein one compute node of the plurality of compute nodes is configured to execute two or more of the plurality of applications.

5. The method of claim 1, wherein the minimum node availability budget for the application requires that at least one compute node running the application be live at all times.

6. The method of claim 5, wherein generating the batch upgrade scheme to comply with the minimum node availability budget for the application comprises ensuring that fewer than all compute nodes running the application are upgraded simultaneously such that at least one compute node running the application is live at all times.

7. The method of claim 1, wherein generating the batch upgrade scheme further comprises optimizing the batch upgrade scheme to ensure that sufficient resources are available to continue operations during the upgrade process.

8. The method of claim 7, wherein the sufficient resources comprises:
sufficient CPU (central processing unit) resources are available to continue operations;
sufficient GPU (graphics processing unit) resources are available to continue operations;
sufficient RAM (random access memory) resources are available to continue operations; and
sufficient disk storage resources are available to continue operations.

9. The method of claim 1, wherein generating the batch upgrade scheme further comprises optimizing the batch upgrade scheme to ensure that sufficient data is available to execute the application during the upgrade process.

10. The method of claim 1, wherein the method is implemented in a containerized workload management platform.

11. The method of claim 10, wherein the containerized workload management platform comprises a Kubernetes® construct.

12. The method of claim 1, wherein the application comprises a plurality of applications, and wherein generating the batch upgrade scheme comprises ensuring that none of the plurality of applications become unavailable during the upgrade process.

13. The method of claim 1, wherein the batch upgrade scheme comprises a plurality of upgrade groups, wherein each of the plurality of upgrade groups comprises one or more compute nodes to be upgraded in parallel, and wherein the plurality of upgrade groups are upgraded serially.

14. The method of claim 1, wherein each of the plurality of compute nodes is associated with a cluster within a containerized workload management system.

15. The method of claim 14, wherein the containerized workload management system comprises a plurality of clusters, and wherein each of the plurality of clusters comprises:
a control plane node comprising an API (application program interface) server in communication with all compute nodes mapped to the applicable cluster.

16. The method of claim 1, wherein generating the batch upgrade scheme comprises first upgrading the control plane node of each of the plurality of clusters prior to upgrading the plurality of compute nodes.

17. The method of claim 1, wherein generating the batch upgrade scheme further comprises selecting an optimal date and time to execute the batch upgrade scheme.

18. The method of claim 17, wherein selecting the optimal date and time to execute the batch upgrade scheme comprises selecting based on time-based usage history for the application.

19. The method of claim 1, wherein the application is a cloud-based application and wherein the plurality of compute nodes are implemented within a cloud-native network platform.

20. The method of claim 1, wherein each of the plurality of compute nodes comprises one or more pods, and wherein generating the batch upgrade scheme comprises upgrading a plurality of pods in parallel.
